(19) United States
(12) Patent Application Publication
(10) Pub. No.: US 2025/0347452 A1
(43) Pub. Date: Nov. 13, 2025

(54) DETECTION AND MITIGATION OF COOLANT LEAKS IN MULTIPLE BRANCH COOLANT SYSTEM VIA TEMPERATURE INDICATORS

(71) Applicant: GM GLOBAL TECHNOLOGY OPERATIONS LLC, Detroit, MI (US)

(72) Inventors: Justin A. Bunnell, Farmington Hills, MI (US); Andres V. Mituta, Lake Orion, MI (US); Benjamin C. Groen, Troy, MI (US); Philip J. Prociw, Clinton Township, MI (US); Jeffrey A. Bednar, South Lyon, MI (US)

(73) Assignee: GM GLOBAL TECHNOLOGY OPERATIONS LLC, Detroit, MI (US)

(21) Appl. No.: 18/657,295

(22) Filed: May 7, 2024

(51) Int. Cl. F25B 49/00; H01M 10/63

(52) U.S. Cl. CPC F25B 49/005; H01M 10/63; F25B 2500/222; F25B 2600/2515; F25B 2700/21

(57) ABSTRACT

A coolant leak detection and mitigation system for a rechargeable energy storage system having multiple battery cells arranged in individual battery modules includes a cooling system having a main coolant loop and multiple parallel coolant branches. Each coolant branch adjusts the temperature of one battery module using a portion of coolant from the main coolant loop. The cooling system also has flow-valve(s) for regulating and distributing the coolant from the main coolant loop across the coolant branches. An electronic controller is configured to command a change in coolant temperature in the main coolant loop. The controller is also configured to monitor temperature change in each battery module in response to the main coolant loop temperature change. The controller is additionally configured to identify a battery module exhibiting a temperature change indicative of a coolant leak and shut off coolant flow into the coolant branch of the affected battery module.

### INTRODUCTION

The present disclosure relates to detection and mitigation of coolant leaks in a multiple branch coolant system for a multi-cell rechargeable energy storage system (RESS) using temperature indicators.

Typically, an electric energy generation and storage battery system includes one or more battery cells for powering a load. A plurality of battery cells may be arranged in close proximity to one another to generate a battery module and a plurality of battery modules may be organized into a battery pack array. Batteries may be broadly classified into primary and secondary batteries. Primary batteries, also referred to as disposable batteries, are intended to be used until depleted, after which they are simply replaced with new batteries. Secondary batteries, more commonly referred to as rechargeable batteries, employ specific chemistries permitting such batteries to be repeatedly recharged and reused, therefore offering economic, environmental, and ease-of-use benefits compared to disposable batteries.

Rechargeable batteries may be used to power such diverse items as toys, consumer electronics, and motor vehicles. Particular chemistries of rechargeable batteries, such as lithium-ion cells, as well as external factors, may cause internal reaction rates generating significant amounts of thermal energy. Exposure of a battery cell to elevated temperatures over prolonged periods may cause the cell to experience a thermal runaway event, where heat build-up in an individual cell leads to the heat spreading to adjacent cells in the module and affecting the entire battery array. Accordingly, thermal energy needs to be effectively removed to mitigate heat build-up and consequent degradation of battery system performance. Generally, devices such as heat-sinks or cold-plates with circulating coolant are employed to remove heat from battery systems.

### SUMMARY

A coolant leak detection and mitigation system for a multi-cell rechargeable energy storage system (RESS) having a plurality of battery cells arranged in individual battery modules includes a cooling system. The cooling system has a main coolant loop configured to circulate coolant. The cooling system also has a plurality of coolant branches arranged fluidly in parallel. Each coolant branch is configured to receive a portion of the coolant from the main coolant loop to adjust the temperature of one of the respective battery modules. The cooling system additionally has at least one flow-valve configured to regulate and distribute across the plurality of coolant branches the coolant circulated through the main coolant loop. The coolant leak detection and mitigation system also includes an electronic controller in operative communication with the cooling system.

The electronic controller is configured to command a predetermined change in temperature of the coolant in the main coolant loop. The electronic controller is also configured to monitor, via individual temperature indicators, temperature change in each of the individual battery modules in response to the commanded change in temperature of the coolant in the main coolant loop. The electronic controller is additionally configured identify a battery module, from among the individual battery modules, exhibiting a temperature change indicative of a coolant leak. The electronic controller is further configured to shut off, via the flow-valve(s), a flow of the coolant into the coolant branch of the battery module having the temperature change indicative of a coolant leak.

The electronic controller may be configured to regulate temperature of the individual battery modules by apportioning the flow of the coolant between the plurality of coolant branches via the flow-valve(s).

The electronic controller may be additionally configured to set an alert indicative of the coolant leak and the flow of the coolant having been shut off into the corresponding coolant branch.

The flow-valve may be a multi-way valve assembly arranged in a junction between the main coolant loop and the plurality of coolant branches. Such a multi-way valve may be configured to control the flow of the coolant into each of the coolant branches.

Alternatively, a plurality of throttle valves may regulate the flow of the coolant from the main coolant loop. Each throttle valve may be arranged in one of the coolant branches upstream of the corresponding battery module and be configured to control the flow of the coolant into the subject coolant branch.

Each coolant branch may include a one-way valve configured to control the flow of the coolant out of the subject coolant branch.

The cooling system may also include a fluid pump configured to circulate the coolant through the main coolant loop.

The cooling system may additionally include a coolant chiller configured to remove thermal energy from the coolant in the main coolant loop.

The cooling system may also include a coolant heater configured to add thermal energy to the coolant in the main coolant loop.

The cooling system may additionally include a first temperature sensor in communication with the electronic controller and configured to detect temperature of the coolant in the main coolant loop.

Each battery module may also include a second temperature sensor in communication with the electronic controller. Each second temperature sensor may be one of the individual temperature indicators configured to detect temperature of a portion of the coolant in a respective coolant branch.

Each battery module may also include a third temperature sensor in communication with the electronic controller. Each third temperature sensor may be one of the individual temperature indicators configured to detect temperature of a respective battery module.

A motor vehicle employing a coolant leak detection and mitigation system, as described above, and a method of detecting and mitigating a coolant leak in a multi-cell rechargeable energy storage system (RESS) are also disclosed.

The above features and advantages, and other features and advantages of the present disclosure, will be readily apparent from the following detailed description of the embodiment(s) and best mode(s) for carrying out the described disclosure when taken in connection with the accompanying drawings and appended claims.

### BRIEF DESCRIPTION OF THE DRAWINGS

FIG. 1 is a schematic top view of an embodiment of a motor vehicle employing multiple power-sources and a multi-cell rechargeable energy storage system (RESS) configured to generate and store electrical energy used by vehicle systems including the power-sources, according to the disclosure.

FIG. 2 is a schematic illustration of the RESS shown in FIG. 1, including an embodiment of a coolant system having a main coolant loop and multiple parallel coolant branches subsystem for removing thermal energy from individual battery modules and individual temperature indicators for detecting temperature changes in battery modules indicative of coolant leaks, according to the disclosure.

FIG. 3 is a schematic illustration of the RESS shown in FIG. 1, including another embodiment of a coolant system having a main coolant loop and multiple parallel coolant branches subsystem for removing thermal energy from individual battery modules and temperature indicators for detecting temperature changes in battery modules indicative of coolant leaks, according to the disclosure.

FIG. 4 illustrates a method of detecting and mitigating a coolant leak in the multi-cell RESS shown in FIGS. 1-3.

### DETAILED DESCRIPTION

Embodiments of the present disclosure as described herein are intended to serve as examples. Other embodiments may take various and alternative forms. Additionally, the drawings are generally schematic and not necessarily to scale. Some features may be exaggerated or minimized to show details of particular components. Therefore, specific structural and functional details disclosed herein are not to be interpreted as limiting, but merely as a representative basis for teaching one skilled in the art to variously employ the present disclosure.

Certain terminology may be used in the following description for the purpose of reference only, and thus are not intended to be limiting. For example, terms such as “above” and “below” refer to directions in the drawings to which reference is made. Terms such as “front”, “back”, “fore”, “aft”, “left”, “right”, “rear”, “side”, “upward”, “downward”, “top”, and “bottom”, etc., describe the orientation and/or location of portions of the components or elements within a consistent but arbitrary frame of reference, which is made clear by reference to the text and the associated drawings describing the components or elements under discussion.

Furthermore, terms such as “first”, “second”, “third”, and so on may be used to describe separate components. Such terminology may include the words specifically mentioned above, derivatives thereof, and words of similar import, and are used descriptively for the figures, and do not represent limitations on the scope of the disclosure, as defined by the appended claims. Moreover, the teachings may be described herein in terms of functional and/or logical block components and/or various processing steps. It should be realized that such block components may include a number of hardware, software, and/or firmware components configured to perform the specified functions.

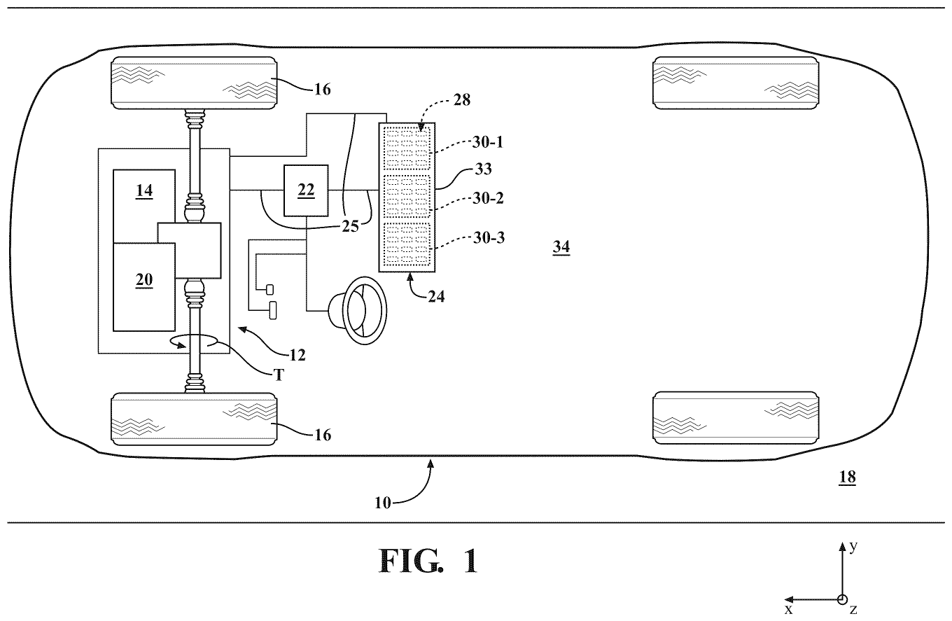

Referring to the drawings, wherein like reference numbers refer to like components, FIG. 1 shows a schematic view of a motor vehicle 10 having a powertrain 12. The vehicle 10 may include, but not be limited to, a commercial vehicle, industrial vehicle, passenger vehicle, aircraft, watercraft, train or the like. It is also contemplated that the vehicle 10 may be a mobile platform, such as an airplane, all-terrain vehicle (ATV), boat, personal movement apparatus, robot and the like to accomplish the purposes of this disclosure. The powertrain 12 includes a power-source 14 configured to generate a power-source torque T (shown in FIG. 1) for propulsion of the vehicle 10 via driven wheels 16 relative to a road surface 18. The power-source 14 is depicted as an electric motor-generator.

As shown in FIG. 1, the powertrain 12 may include an additional power-source 20, such as an internal combustion engine. The power-sources 14 and 20 may act in concert to power the vehicle 10. The vehicle 10 additionally includes a central processing unit (CPU) 22 and a multi-cell rechargeable energy storage system (RESS) 24 configured to generate and store electrical energy through heat-producing electro-chemical reactions for supplying the electrical energy to the power-sources 14 and 20. The CPU 22 regulates various systems of the vehicle 10, including the powertrain 12 to generate a predetermined amount of power-source torque T. The RESS 24 may be connected to the power-sources 14 and 20, to the CPU 22, as well as to other vehicle systems via a high-voltage BUS 25.

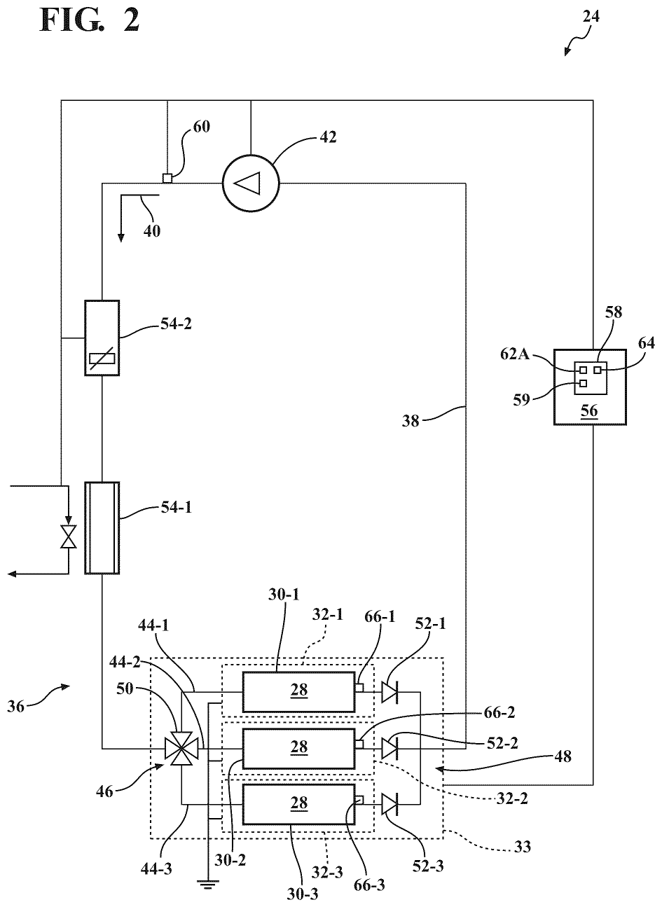

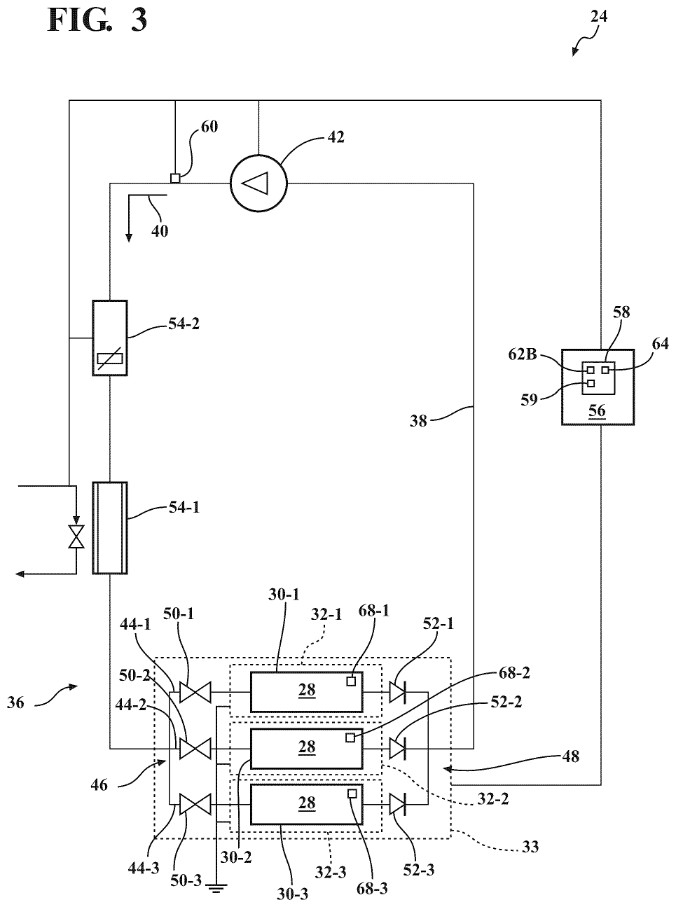

As shown in FIGS. 1-3, the RESS 24 includes a plurality of battery cells 28 arranged in individual battery groups or modules, such as a first module 30-1, a second module 30-2, and a third module 30-3. The subject modules 30-1, 30-2, 30-3 may be arranged electrically in series or in parallel. Although three individual battery modules are specifically shown, it is intended that the RESS 24 includes at least two respective modules, and multiple modules may be organized into battery packs or subpacks. The remainder of the present description will focus on RESS 24 construction having three battery modules 30-1, 30-2, 30-3, with each battery module having a desired quantity of battery cells 28. As shown in FIGS. 2 and 3, each battery module 30-1, 30-2, 30-3 may include a respective battery module enclosure 32-1, 32-2, 32-3 configured to house and support the corresponding battery cells 28. The RESS 24 may also include a battery pack enclosure 33 surrounded by an ambient environment 34. The battery pack enclosure 33 is configured to house and support the battery modules 30-1, 30-2, 30-3 (shown in FIG. 1).

As shown in FIGS. 2 and 3, RESS 24 also includes a cooling system 36 configured to remove thermal energy from various temperature sensitive components of the RESS. Cooling system 36 includes a main coolant loop 38 configured to circulate a coolant 40 through the RESS 24. As shown, cooling system 36 further includes a fluid pump 42 configured to circulate coolant 40 through the main coolant loop 38. The cooling system 36 also includes a plurality of coolant branches, shown as a first branch 44-1, a second branch 44-2, and a third branch 44-3, in fluid communication with the main coolant loop 38. Each of the coolant branches 44-1, 44-2, 44-3 extends through a respective battery module 30-1, 30-2, 30-3, proximate and along the constituent battery cells 28.

Furthermore, each coolant branch 44-1, 44-2, 44-3 is configured to receive a portion of the coolant 40 from the main coolant loop 38. The coolant branches 44-1, 44-2, 44-3 are arranged fluidly in parallel to receive respective portions of the coolant 40. The coolant branches 44-1, 44-2, 44-3 are thereby configured to independently circulate their respective portions of the coolant 40 and adjust the temperature of the corresponding battery modules 30-1, 30-2, 30-3 (by removing or adding thermal energy). As shown, the main coolant loop 38 may be in fluid communication with additional parallel coolant branches, for example to circulate the coolant through auxiliary power modules (APMs), a Battery Disconnect Unit (BDU) including various electrical switches and relays, electrical connectors, a DC/DC converter for supplying 12V/48V power to the vehicle, etc., each having a particular temperature requirement.

With continued reference to FIGS. 2 and 3, the RESS 24 may also include an inlet manifold 46 configured to connect the main coolant loop 38 to the coolant branches 44-1, 44-2, 44-3 and an outlet manifold 48 configured to connect the coolant branches back to the main coolant loop. Accordingly, the inlet and outlet manifolds 46, 48 are together configured to maintain circulation of coolant 40 through the cooling system 36. The cooling system 36 additionally includes at least one flow-valve 50. The flow-valve(s) 50 are configured to regulate and distribute across the individual coolant branches 44-1, 44-2, 44-3, the coolant 40 circulated through and received from the main coolant loop 38. In other words, the flow-valve(s) 50 are specifically structured and operated to provide independent regulation of coolant flow into each individual coolant branch 44-1, 44-2, 44-3.

As shown in FIG. 2, the flow-valve 50 may be a multi-way valve assembly arranged in a junction, such as the inlet manifold 46, between the main coolant loop 38 and the plurality of coolant branches 44-1, 44-2, 44-3 upstream of each battery module 30-1, 30-2, 30-3. The multi-way valve assembly embodiment of the flow-valve 50 may be configured to control the flow of coolant 40 into each of the coolant branches 44-1, 44-2, 44-3. As shown in FIG. 3, the flow-valve(s) 50 may be a plurality of individual throttle valves 50-1, 50-2, 50-3. Each subject throttle valve 50-1, 50-2, 50-3 may be arranged in one of the plurality of coolant branches 44-1, 44-2, 44-3 upstream of the corresponding battery module 30-1, 30-2, 30-3 and configured to control the flow of the coolant 40 into the subject coolant branch.

As shown in FIGS. 2 and 3, each coolant branch 44-1, 44-2, 44-3 may include a respective one-way valve 52-1, 52-2, 52-3. The one-way valves 52-1, 52-2, 52-3 are configured to prevent backflow of the coolant 40 into the corresponding coolant branches 44-1, 44-2, 44-3. Each of the one-way valves 52-1, 52-2, 52-3 is arranged aft of the flow-valve(s) 50 and downstream of the corresponding battery module 30-1, 30-2, 30-3. Accordingly, each one-way valve 52-1, 52-2, 52-3 is configured to control the flow of the corresponding portion of the coolant 40 through and out of the subject coolant branch 44-1, 44-2, 44-3. Cooling system 36 may also include a plurality of heat exchangers arranged in the main coolant loop 38 to alter the temperature of the coolant 40. For example, one embodiment of such a heat exchanger may be a coolant chiller 54-1, for example, using a refrigerant, to remove thermal energy from the coolant 40 in the main coolant loop 38. Another embodiment of such a heat exchanger may be a coolant heater 54-2, for example, using electrical resistance, to add thermal energy to the coolant 40.

As shown in FIGS. 2 and 3, the multi-cell RESS 24 may additionally include an electronic controller 56 that may be either electronically connected to or be part of the CPU 22. The electronic controller 56 may be configured or programmed to regulate operation of the cooling system 36 or be structured to manage operation of the RESS 24 as a whole. As shown, the electronic controller 56 is in operative communication with the fluid pump 42, the flow-valve(s) 50, the coolant chiller 54-1, and the coolant heater 54-2. To support requisite management of the RESS 24 and/or the cooling system 36, the electronic controller 56 specifically includes a processor and tangible, non-transitory memory, which includes requisite instructions programmed therein. The controller's memory may be an appropriate recordable medium that participates in providing computer-readable data or process instructions. Such a recordable medium may take many forms, including but not limited to non-volatile media and volatile media.

Non-volatile media for electronic controller 56 may include, for example, optical or magnetic disks and other persistent memory. Volatile media may include, for example, dynamic random-access memory (DRAM), which may constitute a main memory. The instructions programmed into the controller 56 may be transmitted by one or more transmission medium, including coaxial cables, copper wire and fiber optics, including the wires that comprise a system bus coupled to a processor of a computer, or via a wireless connection. Memory of the electronic controller 56 may also include a flexible disk, hard disk, magnetic tape, another magnetic medium, a CD-ROM, DVD, another optical medium, etc. The electronic controller 56 may be configured or equipped with other required computer hardware, such as a high-speed clock, requisite Analog-to-Digital (A/D) and/or Digital-to-Analog (D/A) circuitry, input/output circuitry and devices (I/O), as well as appropriate signal conditioning and/or buffer circuitry.

The electronic controller 56 may be configured to regulate the flow of coolant 40 into the individual battery modules 30-1, 30-2, 30-3 via the fluid pump 42 and the flow-valve(s) 50. Algorithm(s), indicated generally via numeral 58, required by the electronic controller 56 or accessible thereby may be stored in the memory of the controller and automatically executed to facilitate operation of the RESS 24 and/or the cooling system 36. Specifically, the algorithm(s) 58 may include an inventory mode configured to monitor operation of the fluid pump 42, the flow-valve(s) 50, the coolant chiller 54-1, and the coolant heater 54-2. The electronic controller 56 may be additionally configured to regulate the temperature of individual battery modules 30-1, 30-2, 30-3 via at least one of the fluid pump 42, the coolant chiller 54-1, and the coolant heater 54-2.

The electronic controller 56 may be further configured, e.g., via the algorithm(s) 58, to regulate temperature of the individual battery modules 30-1, 30-2, 30-3 by apportioning the flow of coolant 40 between the individual coolant branches 44-1, 44-2, 44-3 via the flow-valve(s) 50. Specifically, the electronic controller 56 is programmed to command a predetermined change 59 (either an increase or a decrease) in temperature of the coolant 40 in the main coolant loop 38. The cooling system 36 additionally includes a first temperature sensor 60 in communication with the electronic controller 56. The first temperature sensor 60 is configured to detect temperature of the coolant 40 in the main coolant loop 38. The first temperature sensor 60 may be used by the electronic controller 56 to achieve closed-loop or feedback control of coolant temperature in the main coolant loop 38.

The electronic controller 56 is additionally programmed to monitor, via individual temperature indicators, a temperature change in each of the individual battery modules 30-1, 30-2, 30-3 in response to the commanded change 59 in coolant temperature within the main coolant loop 38. The temperature change in battery modules 30-1, 30-2, 30-3 may be assessed continuously, at regular time intervals, or at every key-on of the vehicle 10. The electronic controller 56 is also programmed to identify a battery module, from among the RESS battery modules, e.g., 30-1, 30-2, 30-3, that exhibits an anomalous temperature change in response to the predetermined temperature change 59 of the coolant 40 in the main coolant loop 38. Such an anomalous temperature change may be interpreted by the electronic controller 56 as an indicator of a coolant leak.

Generally, the correlation of individual battery module temperature to temperature of coolant in the main loop may be determined empirically, via testing of a representative RESS, and programmed into the controller 56. Such a correlation may be used to establish acceptable or target temperatures for constituent battery modules resulting from particular coolant temperature variations in the main coolant loop 38. A smaller than predicted temperature change inside a battery module for a given coolant temperature change in the main coolant loop 38 may be indicative of insufficient coolant circulation through the particular module.

Specifically, a coolant temperature change inside an individual coolant branch 44-1, 44-2, 44-3 in response to the predetermined coolant temperature change 59 in the main coolant loop 38 being below a corresponding threshold value 62A (shown in FIG. 2) is deemed indicative of a coolant leak inside the subject battery module. Alternatively, a temperature of the environment and/or components of the battery modules 30-1, 30-2, 30-3 inside a battery module enclosure 32-1, 32-2, 32-3 in response to the predetermined coolant temperature change 59 in the main coolant loop 38 being below a corresponding threshold value 62B (shown in FIG. 3) may also be deemed indicative of a coolant leak inside the subject battery module. The threshold values 62A, 62B may be established individually for each battery module 30-1, 30-2, 30-3 and programmed into the controller 56.

The controller 56 is also programmed to shut off the flow of coolant 40 into one or more battery module 30-1, 30-2, 30-3 exhibiting the temperature change indicative of a coolant leak, i.e., via the flow-valve(s) 50 into the appropriate branch(s) 44-1, 44-2, 44-3. For example, the coolant flow may be shut off to the branch 44-1 using the multi-way valve 50 or the throttle valve 50-1. The electronic controller 56 may be additionally configured to set, i.e., command or trigger, an alert 64 indicative of the coolant leak identified in a particular battery module 30-1, 30-2, or 30-3 and the flow of the coolant having been shut off to that module. In other words, the alert 64 may inform a system user or a technician directly via a sensory signal or a trouble code or via a remote server (not shown) that a specific coolant branch is compromised and coolant flow therethrough has been blocked.

As shown in FIG. 2, each battery module 30-1, 30-2, 30-3 may additionally include a second temperature sensor, identified with respective numerals 66-1, 66-2, and 66-3, positioned inside the respective coolant branch 44-1, 44-2, 44-3 and in communication with the electronic controller 56. Each second temperature sensor 66-1, 66-2, 66-3 may be one of the individual temperature indicators configured to detect temperature of a respective battery module 30-1, 30-2, 30-3 by detecting the temperature of a portion of the coolant 40 in a respective coolant branch 44-1, 44-2, 44-3. The electronic controller 56 may be programmed to compare the detected temperature of the coolant 40 in each coolant branch 44-1, 44-2, 44-3 to the threshold value 62A to identify a coolant branch with a coolant leak.

Alternatively, or in addition to the second temperature sensor 66-1, 66-2, or 66-3, each battery module 30-1, 30-2, 30-3 may include a respective third temperature sensor 68-1, 68-2, 68-3 (shown in FIG. 3). Each third temperature sensor 68-1, 68-2, 68-3 is positioned inside the respective battery module enclosure 32-1, 32-2, 32-3 to detect temperature of the environment and/or components of the battery modules 30-1, 30-2, 30-3. Analogous to the second sensors, each third temperature sensor 68-1, 68-2, 68-3 is in communication with the electronic controller 56 and may be one of the individual temperature indicators configured to detect the temperature of a respective battery module. The electronic controller 56 may be programmed to compare the detected temperature of each respective battery module 30-1, 30-2, 30-3 to the threshold value 62B to identify a battery module with a coolant leak.

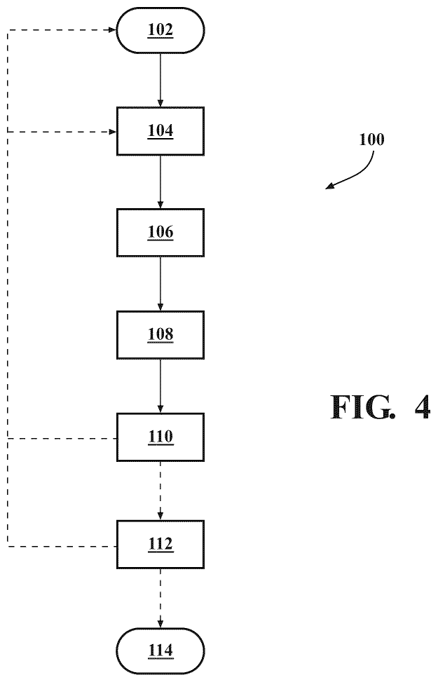

A method 100 of detecting and mitigating a coolant leak in a multi-cell rechargeable energy storage system, such as the RESS 24, as shown in FIG. 4 and described below with reference to the structure shown in FIGS. 1-3. The method is specifically for use in the RESS employing a main coolant loop connected to a fluid pump, e.g., the main coolant loop 38 and a plurality of coolant branches, e.g., branches 44-1, 44-2, 44-3, arranged in parallel, each configured to receive a portion of the coolant 40 from the main coolant loop. The subject RESS also employs at least one flow-valve 50 configured to regulate and distribute the coolant 40 received from main coolant loop 38 across the plurality of coolant branches 44-1, 44-2, 44-3.

Method 100 commences in frame 102 with regulating, via the electronic controller 56, temperature and flow of coolant 40 in the cooling system 36 and specifically in the main coolant loop 38. After frame 102, the method proceeds to frame 104. In frame 104 the method includes commanding, via the electronic controller 56 using either the coolant chiller 54-1 or the coolant heater 54-2, the predetermined change 59 in temperature of the coolant 40 in the main coolant loop 38. The predetermined change 59 in temperature of the coolant 40 may be achieved with the aid of a signal from the first temperature sensor 60. Following frame 104, the method advances to frame 106.

In frame 106, the method includes monitoring, via the electronic controller 56 temperature change in each of the individual battery modules 30-1, 30-2, 30-3 in response to the commanded temperature change 59 of coolant 40 in the main coolant loop 38. As described above with respect to FIGS. 2-3, the electronic controller 56 monitors the temperature change in the battery modules 30-1, 30-2, 30-3 using one or more individual temperature indicators, e.g., second temperature sensors 66-1, 66-2, 66-3 and/or third temperature sensors 68-1, 68-2, 68-3. As described with respect to FIGS. 2-3, the second temperature sensors 66-1, 66-2, 66-3 detect temperature of the coolant 40 in respective coolant branches 44-1, 44-2, 44-3, while the third temperature sensors 68-1, 68-2, 68-3 detect temperature of the environment and/or components in the battery modules 30-1, 30-2, 30-3. Following frame 106, the method moves on to frame 108.

In frame 108, method includes identifying, via the electronic controller 56, from among the constituent modules 30-1, 30-2, 30-3, a battery module exhibiting a temperature change indicative of a coolant leak in a corresponding coolant branch 44-1, 44-2, or 44-3. The subject temperature change may be detected either in the battery module components, such as the battery cells, or of the coolant 40 inside a corresponding coolant branch 44-1, 44-2, 44-3. The identification of a specific battery module affected by a coolant leak may be based on a comparison of the detected temperature of the coolant 40 in each coolant branch 44-1, 44-2, 44-3 to the threshold value 62A or a comparison of the detected temperature of each respective battery module 30-1, 30-2, 30-3 to the threshold value 62B. After frame 108, the method proceeds to frame 110.

In frame 110, the method includes shutting off, via the flow-valve(s) 50, a flow of the coolant 40 into the coolant branch 44-1, 44-2, or 44-3 of the battery module having the temperature change indicative of the identified coolant leak. After frame 110, the method may proceed to frame 112. In frame 112, following shutting off the coolant flow into the coolant branch affected by the leak, the method includes setting, via the electronic controller 56, the alert 64 signaling the detected existence of the coolant leak. The alert 64 may identify the affected coolant branch and/or the fact that the flow of the coolant has been shut off. Following either frame 110 or frame 112, the method may loop back to frame 102 for continued regulation of the temperature and flow of the coolant 40 in the cooling system 36 or to frame 104 for another command of the predetermined change 59 in temperature of the coolant 40 in the main coolant loop 38. Otherwise, for example, if vehicle 10 has come to a stop, the power-sources 14 and 20 have been switched off, and the fluid pump 42 has been deactivated, the method may conclude in frame 114.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings, or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework and the scope of the appended claims.

What is claimed is:

1. A coolant leak detection and mitigation system for a multi-cell rechargeable energy storage system (RESS) having a plurality of battery cells arranged in individual battery modules, the coolant leak detection and mitigation system comprising:
a cooling system including:
a main coolant loop configured to circulate coolant;
a plurality of coolant branches arranged in parallel, wherein each coolant branch is configured to receive a portion of the coolant from the main coolant loop to adjust temperature of one of the respective battery modules; and
at least one flow-valve configured to regulate and distribute across the plurality of coolant branches the coolant circulated through the main coolant loop; and
an electronic controller in operative communication with the cooling system and configured to:
command a predetermined change in temperature of the coolant in the main coolant loop;
monitor, via individual temperature indicators, temperature change in each of the individual battery modules in response to the commanded change in temperature of the coolant in the main coolant loop;
identify a battery module, from among the individual battery modules, exhibiting a temperature change indicative of a coolant leak in a corresponding coolant branch; and
shut off, via the at least one flow-valve, a flow of the coolant into the coolant branch having the coolant leak.

2. The coolant leak detection and mitigation system of claim 1, wherein the electronic controller is additionally configured to set an alert indicative of the coolant leak and the flow of the coolant having been shut off into the corresponding coolant branch.

3. The coolant leak detection and mitigation system of claim 1, wherein the at least one flow-valve is a multi-way valve assembly arranged in a junction between the main coolant loop and the plurality of coolant branches and configured to control a flow of the coolant into each of the coolant branches.

4. The coolant leak detection and mitigation system of claim 1, wherein the at least one flow-valve is a plurality of throttle valves, each throttle valve arranged in one of the plurality of coolant branches upstream of the corresponding battery module and configured to control a flow of the coolant into the subject coolant branch.

5. The coolant leak detection and mitigation system of claim 1, wherein each coolant branch includes a one-way valve configured to control a flow of the coolant out of the subject coolant branch.

6. The coolant leak detection and mitigation system of claim 1, wherein the cooling system additionally includes a fluid pump in operative communication with the electronic controller and configured to circulate the coolant through the main coolant loop.

7. The coolant leak detection and mitigation system of claim 1, wherein the cooling system additionally includes:
a coolant chiller in operative communication with the electronic controller and configured to remove thermal energy from the coolant in the main coolant loop; and
a coolant heater in operative communication with the electronic controller and configured to add thermal energy to the coolant in the main coolant loop.

8. The coolant leak detection and mitigation system of claim 1, wherein the cooling system additionally includes a first temperature sensor in communication with the electronic controller, and wherein the first temperature sensor is configured to detect temperature of the coolant in the main coolant loop.

9. The coolant leak detection and mitigation system of claim 1, wherein each battery module additionally includes a second temperature sensor in communication with the electronic controller, and wherein each second temperature sensor is one of the individual temperature indicators configured to detect temperature of a portion of the coolant in a respective coolant branch.

10. The coolant leak detection and mitigation system of claim 1, wherein each battery module additionally includes a third temperature sensor in communication with the electronic controller, and wherein each third temperature sensor is one of the individual temperature indicators configured to detect temperature of a respective battery module.

11. A method of detecting and mitigating a coolant leak in a multi-cell rechargeable energy storage system (RESS) having a plurality of battery cells arranged in individual battery modules, the method comprising:
regulating, via an electronic controller in operative communication with individual temperature indicators, temperature and flow of coolant in a cooling system, the cooling system including:
a main coolant loop configured to circulate the coolant;
a plurality of coolant branches arranged in parallel, wherein each coolant branch is configured to receive a portion of the coolant from the main coolant loop to adjust temperature of one of the respective battery modules; and
at least one flow-valve configured to regulate and distribute across the plurality of coolant branches the coolant circulated through the main coolant loop;
commanding, via the electronic controller, a predetermined change in temperature of the coolant in the main coolant loop;
monitoring, via the individual temperature indicators, temperature change in each of the individual battery modules in response to the commanded change in temperature of the coolant in the main coolant loop;
identifying, via the electronic controller, a battery module, from among the individual battery modules, exhibiting a temperature change indicative of a coolant leak; and
shutting off, via the at least one flow-valve, a flow of the coolant into the coolant branch of the battery module having the temperature change indicative of a coolant leak.

12. The method of claim 11, further comprising setting, via the electronic controller, an alert indicative of the coolant leak and the flow of the coolant having been shut off into the corresponding coolant branch.

13. The method of claim 11, wherein the cooling system additionally includes a first temperature sensor in communication with the electronic controller, the method further comprising detecting, via the first temperature sensor, temperature of the coolant in the main coolant loop.

14. The method of claim 11, wherein each battery module additionally includes a second temperature sensor in communication with the electronic controller, and wherein each second temperature sensor is one of the individual temperature indicators, the method further comprising detecting temperature of a portion of the coolant in each respective coolant branch via the corresponding second temperature sensor.

15. The method of claim 11, wherein each battery module additionally includes a third temperature sensor in communication with the electronic controller, and wherein each third temperature sensor is one of the individual temperature indicators, the method further comprising detecting temperature of a respective battery module via the corresponding third temperature sensor.

16. A motor vehicle comprising:
an electric motor-generator configured to generate torque;
a multi-cell rechargeable energy storage system (RESS) configured to supply electrical energy to the electric motor-generator, the RESS including:
a plurality of battery cells arranged in individual battery modules; and
a cooling system including:
a main coolant loop configured to circulate coolant;
a plurality of coolant branches arranged in parallel, wherein each coolant branch is configured to receive a portion of the coolant from the main coolant loop to adjust temperature of one of the respective battery modules; and
at least one flow-valve configured to regulate and distribute across the plurality of coolant branches the coolant circulated through the main coolant loop;
wherein each coolant branch includes a one-way valve configured to control a flow of the corresponding portion of the coolant out of the subject coolant branch; and
an electronic controller in operative communication with the cooling system and configured to:
command a predetermined change in temperature of the coolant in the main coolant loop;
monitor, via individual temperature indicators, temperature change in each of the individual battery modules in response to the commanded change in temperature of the coolant in the main coolant loop;
identify a battery module, from among the individual battery modules, exhibiting a temperature change indicative of a coolant leak;
shut off, via the at least one flow-valve, a flow of the coolant into the coolant branch of the battery module having the temperature change indicative of a coolant leak; and
set an alert indicative of the coolant leak and the flow of the coolant having been shut off into the corresponding coolant branch.

17. The motor vehicle of claim 16, wherein the cooling system additionally includes a first temperature sensor in communication with the electronic controller, and wherein the first temperature sensor is configured to detect temperature of the coolant in the main coolant loop.

18. The motor vehicle of claim 16, wherein each battery module additionally includes a second temperature sensor in communication with the electronic controller, and wherein each second temperature sensor is one of the individual temperature indicators configured to detect temperature of a portion of the coolant in a respective coolant branch.

19. The motor vehicle of claim 16, wherein each battery module additionally includes a third temperature sensor in communication with the electronic controller, and wherein each third temperature sensor is one of the individual temperature indicators configured to detect temperature of a respective battery module.

20. The motor vehicle of claim 16, wherein the cooling system additionally includes:
a coolant chiller in operative communication with the electronic controller and configured to remove thermal energy from the coolant in the main coolant loop; and
a coolant heater in operative communication with the electronic controller and configured to add thermal energy to the coolant in the main coolant loop.
